(19) United States
(12) Patent Application Publication
(10) Pub. No.: US 2013/0056487 A1
(43) Pub. Date: Mar. 7, 2013

(54) PRODUCT DISPENSING MACHINE AND DISPENSING METHOD

(71) Applicant: Eric Van Velzen, Amsterdam (NL)

(72) Inventor: Eric Van Velzen, Amsterdam (NL)

(73) Assignee: AUTOMATED RETAIL CONCEPTS B.V., Amsterdam (NL)

(21) Appl. No.: 13/582,594

(22) PCT Filed: Mar. 4, 2011
(86) PCT No.: PCT/NL11/50154

§ 371 Date: Nov. 19, 2012

(30) Foreign Application Priority Data
Mar. 4, 2010 (NL) 2004342

(51) Int. Cl. G07F 11/16

(52) U.S. Cl. 221/1; 221/239

(57) ABSTRACT

The invention relates to a product dispensing machine comprising a motorized collector and a plurality of product trays, each being arranged to store products in line and comprising a dispensing mechanism at an outer end of the tray. The motorized collector is arranged to approach each of said product trays and to move at least one dispensing mechanism from a blocking position, in which said dispensing mechanism blocks a product first in line on said tray, into a dispense position in which the product first in line is removed from the tray onto the collector, said dispensing mechanism being arranged to block a product second in line while being in the dispense position.

### FIELD OF THE INVENTION

The invention relates to a product dispensing machine and a dispensing method. It also relates to a dispensing mechanism used in such a dispensing machine.

### BACKGROUND OF THE INVENTION

Vending machines are known to have a plurality of product trays for storing products before they get dispensed. Some vending machines comprise trays having separate compartments for every product. The separating means take up space and therefore reduce space and also narrow down the variety of dispensable articles. Furthermore, for each tray such vending machines will need a separate motor for driving the articles on the tray towards an outlet.

Publication WO 03/074396 A1 describes a dispensing mechanism which adjusts for dispensing different product packaging formats and dimensions. One or more sliding carrier back-sleds are used which force a product last in line towards the outlet thereby forcing the products in front of the last product in the same direction. The dispensing mechanism of WO 03/074396 A1 does not have separating means for separating the products. But still it needs at least one motor for each product tray. The more motors that are needed, the more expensive the vending machine will become. Furthermore, the chance of a malfunctioning increases with the number of motors as well.

Publication US 2005/0067426 describes a vending machine having an X-Y mechanism for collecting a product from one of the trays of the vending machine. The X-Y mechanism activates a tab of a lever so as to free a first product in line from the tray. The lever mechanism is rather complex and is not suitable for dispensing box-shaped products that have little or no space between them. The same accounts for products packed in boxes.

### OBJECT AND SUMMARY OF THE INVENTION

It is an objective of the invention to provide a product dispensing machine having a plurality of product trays, in which there is no need for separate motors for each product tray and wherein box-shaped products can be dispensed from a tray using a relatively simple mechanism.

In a first aspect, the invention provides a product dispensing machine comprising a motorized collector and a plurality of product trays, each being arranged to store products in line and comprising a dispensing mechanism at an outer end of the tray. The dispensing mechanism comprises a lever mechanism pivot able around a horizontal axis and comprising a first lever arm and a second lever arm. The motorized collector is arranged to approach each of said product trays and to push said first lever arm of the lever mechanism from a blocking position, in which the lever mechanism blocks a product first in line on said tray, into a dispense position in which the product first in line is lifted from the tray and brought onto the collector, said lever mechanism being arranged to block a product second in line while being in the dispense position.

The invention enables easy dispensing of products in boxes or box shaped products that vary in size and weight in a vending machine, maximizing product space and using a minimum of motorized elements, thus reducing production costs, maintenance and incidents.

In an embodiment, the motorized collector is arranged to move said at least one dispensing mechanism from said dispense position back into said blocking position.

In a further embodiment, each of said product trays further comprises a pushing mechanism for pushing a product last in line towards the dispensing mechanism. If the trays are placed horizontal, the gravity force cannot be used, and a pushing mechanism can deliver the necessary force. An example is a sliding carrier back sled.

In a further embodiment, the pushing mechanism is arranged to bias said products on said tray by means of springs, so no additional motor needed to push the products.

The dispensing mechanism may comprise a blocking surface for blocking said product first in line and a pushing surface for pushing said product first in line out of place.

The dispensing mechanism described above may comprise:
a first sheet steel forming said first lever arm, said second lever arm and said pushing surface;
a second sheet steel forming said blocking surface, said second sheet steel being pivot ably connected to said second lever arm.

In a further embodiment, two side edges of the blocking surface are guided by guiding means so as to be forced in a substantially upright position in the blocking position of the dispensing mechanism, and be able to pivot once the dispensing mechanism gets pivoted to a certain degree by the collector. In this configuration, the first product only needs to be lifted just a little bit and will then be pushed forward due to the pushing force of the product behind and or the pushing mechanism.

Preferably, the guiding means comprise a cam having a curved edge at the top.

The invention also relates to a dispensing mechanism for use in a dispensing machine as described above.

Finally, the invention relates to a method of dispensing products out of a dispensing machine as described above, the method comprising:
storing products in line on a plurality of product trays,
blocking a product first in line at an outer end of the trays,
approaching a particular product tray by means of a motorized collector,
moving, by means of said collector, at least one dispensing mechanism from the blocking position, into the dispense position,
blocking a product second in line by said dispensing mechanism while being in the dispense position.

### BRIEF DESCRIPTION OF THE DRAWINGS

The invention and embodiments thereof will now be further elucidated by means of figures. In the figures,

FIG. 1 shows a schematic side view of a product dispensing machine according to an embodiment of the invention;

FIG. 2 schematically shows a front view of the machine of FIG. 1 in which only one product is shown;

FIG. 3 shows a perspective view of a floor according to an embodiment of the invention;

FIG. 4 is a perspective view of a single dispensing mechanism according to an embodiment.

FIG. 5-7 show part of the product tray with the dispensing mechanism in different positions according to the embodiment of FIG. 4.

### DESCRIPTION OF PREFERRED EMBODIMENTS

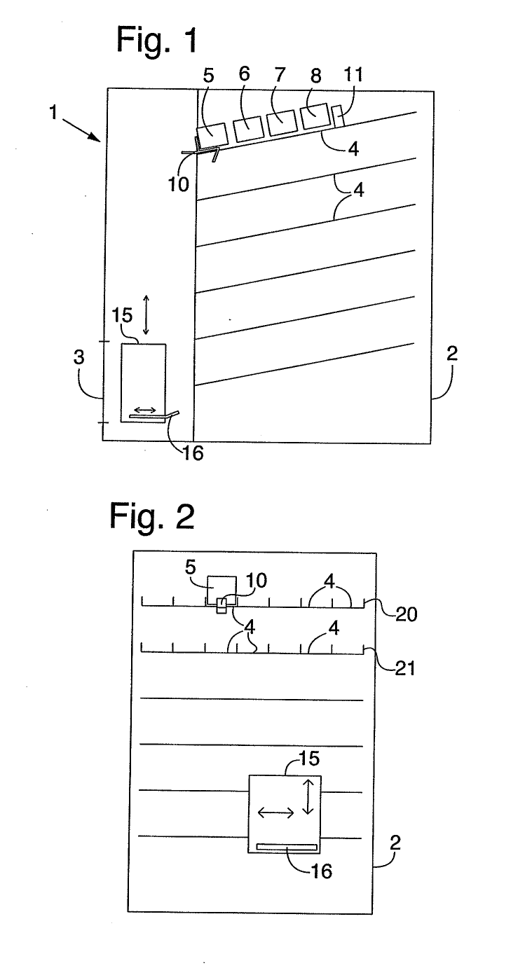

FIG. 1 shows a schematic side view of a product dispensing machine 1 according to an embodiment of the invention. The machine 1 comprises a housing 2 with an outlet opening 3 for taking out an ordered product. The machine 1 comprises a plurality of product trays 4 on which products 5-8 can be stored. At an outer end of each tray 4, one or more dispensing mechanisms 10 are arranged to block a product 5 first in line. In the embodiment of FIG. 1, the last product 8 in line is pushed towards the dispensing mechanism 10 by means of a back sled 11 slidably arranged on said product tray 4.

Furthermore, the machine 1 comprises a collector 15 for collecting a product from one of the trays 4. In an embodiment, the collector comprises an elevator 15 which can move up and down, and from left to right. Inside the elevator 15 a slide is arranged that can be moved out of the elevator 15 as will be explained in more detail below.

FIG. 2 schematically shows a front view of the machine 1 in which only one product is shown, see product 5. FIG. 2 shows that the trays 4 are arranged in so-called floors 20, 21. Each floor 20, 21 may comprise one or more product trays 4.

The elevator 15 can be moved in two dimensions. In this way, the elevator 15 can approach any product tray 4 on any floor 20, 21.

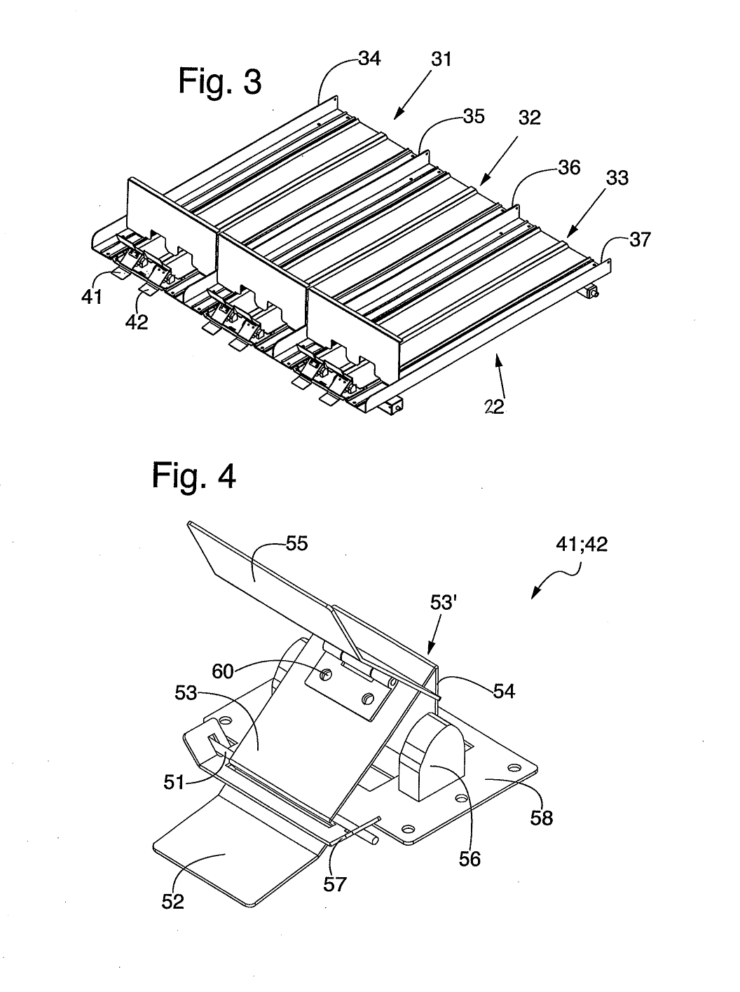

FIG. 3 shows a perspective view of a floor 22 according to an embodiment of the invention. The floor 22 comprises three product trays 31, 32, 33. The trays are defined by walls 34,35,36,37. The trays are preferably manufactured out of aluminum. On the trays between two walls, products can be lined up. Preferably, the products are packed in box-shaped packages. Due to their flat outer surfaces, box-shaped packages can be positioned close to each other.

A single product tray 31, 32, 33 can contain one or multiple dispensing mechanisms depending on the products to be vended. In FIG. 3, the tray 31 contains two dispensing mechanisms 41 and 42.

FIG. 4 is a perspective view of a single dispensing mechanism 41 according to an embodiment. The dispensing mechanism 41 of this embodiment works as a lever and is also referred to as lever mechanism 41. The lever mechanism 41 pivots around an axis 51 which also holds the lever mechanism 41 in its position. The axis 51 is clamped into an axis holder 57 which is arranged next to a base plate 58 of the dispensing mechanism 41. In this embodiment, the axis holder 57 comprises a slit for passing through the lever arm 52. It is noted that in this embodiment the pivot arm 52 comprises two suitable kinks which also make the lever arm more flexible. The dispensing mechanism 41 comprises a first lever arm 52 and a second lever arm 53. In an embodiment, the lever arms 52 and 53 are manufactured out of single sheet steel which results in a strong and simple design. The second lever arm 53 transcends into a first blocking plate 54 which makes an angle a with the second lever arm 53. It is noted that the first blocking plate does not have to be a flat plate. It may be curved, and it may be formed as one or more extensions extending fro the second lever arm 53 in a way so as to block the second product in line in the dispense position.

Near the end of the second lever arm 53, a second blocking plate 55 is pivot ably connected to the second lever arm 53 by means of a hinge 60. That part of the upper surface of the second lever arm 53 which makes contact with the product 5 first in line is also referred to as pushing surface 53. At both sides of the dispensing mechanism 41, guiding means 56 are arranged, see FIG. 4.

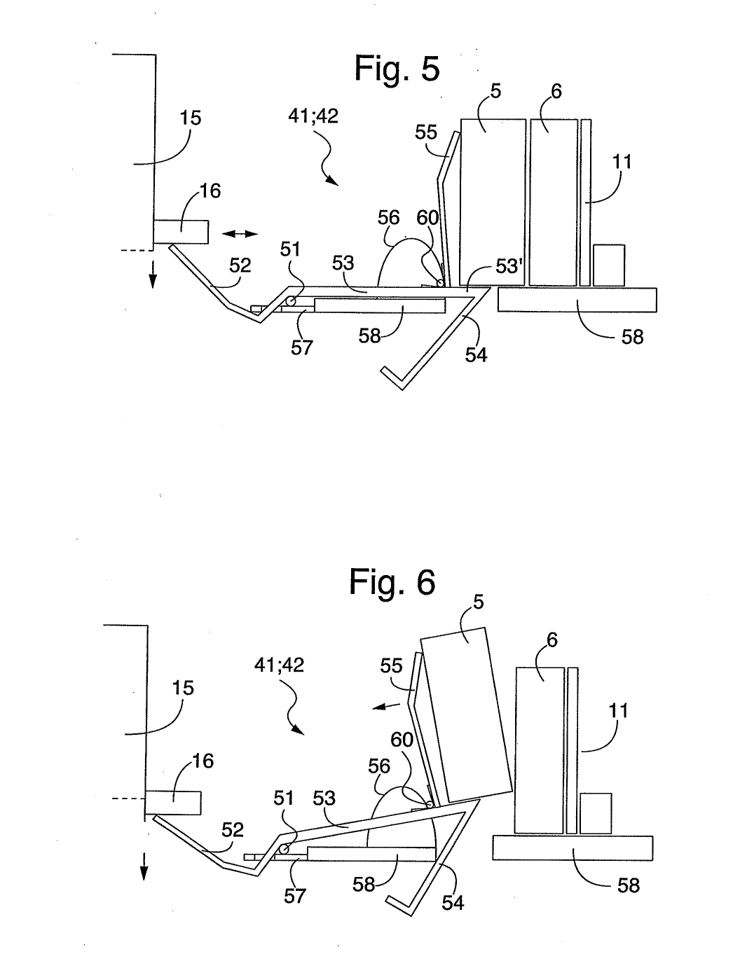

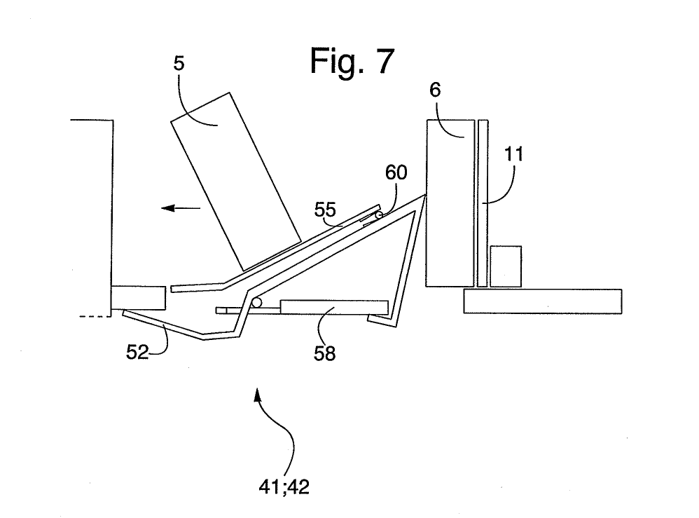

Now, the working of the dispensing mechanism 41 is explained with reference to FIG. 5-7. In FIG. 5 part of the product tray 4 is shown with the dispensing mechanism 41 of FIG. 4. In FIG. 5, the dispensing mechanism 41 is in a blocking position in which the product first in line is prevented from leaving the tray. When collecting a product, the elevator 15 moves above the product tray to be approached. Next, it extends a bucket 16 and moves slowly downward. By moving downward, the bucket 16 will push down on the front of the lever arm 52 resulting in a pivoting/rotating movement about the axis 51, which lifts up the rear end of the second lever arm 53. Once the mechanism 41 starts rotating, the product positioned on the rear end of the second lever arm 53, i.e. product 5, starts moving upward (see FIG. 6) and then forward, sliding along the pivot able second blocking plate 55 on top which subsequently rotates towards the front lever giving the product 5 the possibility to slide over the lever mechanism off the tray, see FIG. 7. The back side of the lever mechanism, i.e. the lever arm 53 and the first blocking plate 54, tilts up when the front is being pushed down, so as to hold the next article in line, thus preventing it from sliding forward off the tray.

In a particular embodiment, the first lever arm 52 and second lever 53 are preferably made out of spring steel which is to a certain extent bendable. This makes it possible to gradually build up a force by the bucket 16 which force is then, at a certain moment in time, transferred onto the opposite side of the lever mechanism to lift up the product first in line. By using a more or less bendable lever arm, the moving bucket 16 will gradually build up the lever force, avoiding unwanted high forces onto the bucket 16, which results in less maintenance and/or a higher life time of the dispensing mechanism (41, 42). Typical values for the thickness of the steel lie between 1-2 mm, other values are possible. Once the product 5 is loaded onto the elevator 15, the bucket 16 will be retracted into the elevator 15, so that the elevator can go down and pass the lever arm 52. Once the bucket 16 is beneath the lever arm 52, it extends again and the elevator 15 will go up so that the lever arm 52 is pushed up and the dispensing mechanism is back into its blocking position. Due to the lever mechanism, the back side of the lever arm 53, i.e. the corner between 53 and 54, pushes the next product, i.e. product 6, a bit back when the front of the lever is being tilted, creating room for the lever mechanism to get back in its blocking position. The two guiding means 56, also referred to as side ridges 56, make sure the second blocking plate 55 is being guided along the rotation. Please note that in this embodiment, the second blocking plate 55 is wider than the lever arm 53. The lever arm 35 is not in contact with the side ridges 56 but at each ridge 56 one side of the second blocking plate 55 is. In the blocking position, see FIG. 5, the second blocking plate 55 is held upright due to a force exerted by the ridges 56 at one side of the plate 55, and a force exerted by the product first in line, at the other side of the plate 55. Due to the specific semi-oval shape of the ridges 56, the plate 55 is not able to pivot in the blocking position of the dispensing mechanism of FIG. 5. It should be noted that other guiding means are possible and that the invention is not restricted to the use of ridges.

The lever mechanism 41, 42 shown in FIGS. 4-7 is capable of dispensing a range of products that vary in size, weight and packaging.

By pushing downward on one side of the lever, the first product is being lifted out of its position from the particular tray. While one side is lifting up the article, the next article in line is being held back by the backside of the lever mechanism. Once the product has been dispensed, the lever arm 52 is pushed upward by moving the elevator 15 upward, so as to move the lever arm 53 downward for receiving the next article in line.

Although the embodiments described above are favorable for dispensing box-shaped products, they may as well be used for non-box-shaped products such as cans or bottles.

A person skilled in the art will readily appreciate that various features disclosed in the description may be modified and that various embodiments disclosed and/or claimed may be combined without departing from the scope of the invention.

1. A product dispensing machine (1) comprising:
a motorized collector (15,16) and,
a plurality of product trays (31,32,33), each being arranged to store products in line and comprising a dispensing mechanism (41, 42) at an outer end of the tray, said dispensing mechanism (41, 42) comprising a lever mechanism pivot able around a horizontal axis (51) and comprising a first lever arm (52) and a second lever arm (53) wherein said motorized collector is arranged to approach each of said product trays and to push said first lever arm (52) of said lever mechanism from a blocking position, in which said lever mechanism blocks a product (5) first in line on said tray, into a dispense position in which the product first in line is lifted from the tray and brought onto the collector, said lever mechanism being arranged to block a product (6) second in line while being in the dispense position.

2. Product dispensing machine according to claim 1, wherein said motorized collector is arranged to move said at least one dispensing mechanism (41, 42) from said dispense position back into said blocking position.

3. Product dispensing machine according to claim 1, wherein each of said product trays further comprises a pushing mechanism (11) for pushing a product last in line towards the dispensing mechanism (41, 42).

4. Product dispensing machine according to claim 3, wherein said pushing mechanism is arranged to bias said products on said tray by means of springs.

5. Product dispensing machine according to claim 1, wherein said dispensing mechanism comprises a blocking surface (55) for blocking said product (5) first in line and a pushing surface (53′) for pushing said product first in line out of place.

6. Product dispensing machine according to claim 5, wherein said dispensing mechanism comprises:
a first sheet steel forming said first lever arm, said second lever arm and said pushing surface;
a second sheet steel forming said blocking surface (55), said second sheet steel being pivot ably connected to said second lever arm.

7. Product dispensing machine according to claim 6, wherein two side edges of said blocking surface are guided by guiding means (56) so as to be forced in a substantially upright position in the blocking position of the dispensing mechanism, and be able to pivot once the dispensing mechanism gets pivoted to a certain degree by the collector.

8. Product dispensing machine according to claim 7, wherein said guiding means (56) comprise a cam (56) having a curved edge at the top.

9. Dispensing mechanism (41, 42) for use in a dispensing machine according to claim 1.

10. A method of dispensing products out of a product dispensing machine according to claim 1, the method comprising:
storing products in line on a plurality of product trays,
blocking a product first in line at an outer end of the trays,
approaching a particular product tray by means of a motorized collector,
moving, by means of said collector, at least one dispensing mechanism from said blocking position, into said dispense position,
blocking a product second in line by said dispensing mechanism while being in the dispense position.

11. Method according to claim 10, wherein said products are packed in boxes.
